(19) United States
(12) Patent Application Publication
(10) Pub. No.: US 2021/0291114 A1
(43) Pub. Date: Sep. 23, 2021

(54) Manual water pump with power multiplier system

(71) Applicant: Alex Deutsch Technologies Ltd, Yehud (IL)

(72) Inventor: Liav Deutsch, Kiryat-Ono (IL)

(73) Assignee: Alex Deutsch Technologies Ltd, Yehud (IL)

(21) Appl. No.: 16/823,377

(22) Filed: Mar. 19, 2020

(51) Int. Cl. B01D 61/10; B01D 33/00

(52) U.S. Cl. CPC B01D 61/10; B01D 2257/408; B01D 2259/4541; B01D 33/0006

(57) ABSTRACT

A lightweight portable manual water purification system that can be operated manually that employs a manual water pump system that can produce a pressure of about six atmospheres solely by using the manual rotation power of the user's hands, and a method for purifying water from cyanide poison.

### TECHNICAL FIELD

The present invention refers to a portable manual water purification system, the method of operation, and a manual water pump.

### BACKGROUND ART

In many cases there is contaminated water nearby and it is necessary to purify it to supply clean water for drinking. For example, military units on the enemy front, rescue units that operate in places where no drinking water is available, and the like. Therefore, it is clear that there is a need for a lightweight, portable manual water purification system. The present invention discloses a method and system that provides an efficient solution for these problems.

### DESCRIPTION OF THE DRAWINGS

The intention of the drawings attached to the application is not to limit the scope of the invention and its application. The drawings are intended only to illustrate the invention and they constitute only one of many possible implementations.

FIG. 1 depicts the manual water pump system (200).

FIG. 2 depicts the manual water pump system (200) schematically.

FIG. 3 depicts a system for purifying water from cyanide (300) schematically.

FIG. 4 depicts a schematically portable manual water purification system (100).

### THE INVENTION

The main object of the present invention is to provide a portable manual water purification system (100) that is relatively lightweight and designed to be carried by a person, together with on that can operate manually and without electrical power. The objective of the present invention is also to provide a manual water pump system (200) that can produce a pressure of about six atmospheres and more solely by using manual rotation power from the user's hands. The present invention is further enhanced to provide a method and system for purifying water from cyanide poison (300).

The manual water pump system (200) includes a gear increaser (210) and a water pump (220). The gear increaser (210) includes an input shaft (211) that is designed to be connected to a manual operating handle (212) and an output shaft (213) that is designed to be connected to the rotor shaft (221) of the water pump (220). The water pump (220) can be, for example, a rotary vane pump that includes a contaminating water inlet (222) and a pressurized water outlet (223).

The gear increaser (210) is designed to increase by least five times the rotational speed of the input shaft (211), and by that enabling the manual water pump system (200) to create water pressure of at least six atmospheres. There is no need to design or manufacture a gear increaser, and it is possible and even recommended to use an existing gear reducer and simply to connect it in reverse. It is possible to apply, for example, the gear reducer of Motovario™ that enables an increase of the speed by five times, and a person can create water pressure of at least six atmospheres by using one hand.

At present, there are no manual water pumps that can provide a pressure of six atmospheres. It is required to have water pressure of about six atmospheres to purify water by reverse osmosis, and the innovative manual water pump system (200) enables the use of the user's hand's power for creating such a degree of water pressure and to process the reverse osmosis purification.

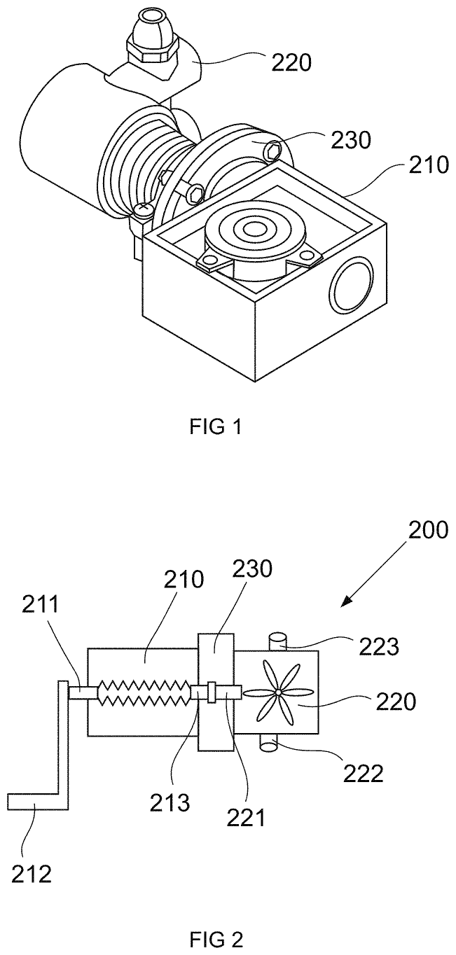

FIG. 1 depicts the manual water pump system (200) that includes the gear increaser (210), the water pump (220), and an adapter (230) for connecting them together. FIG. 2 depicts the manual water pump system (200) and its parts schematically.

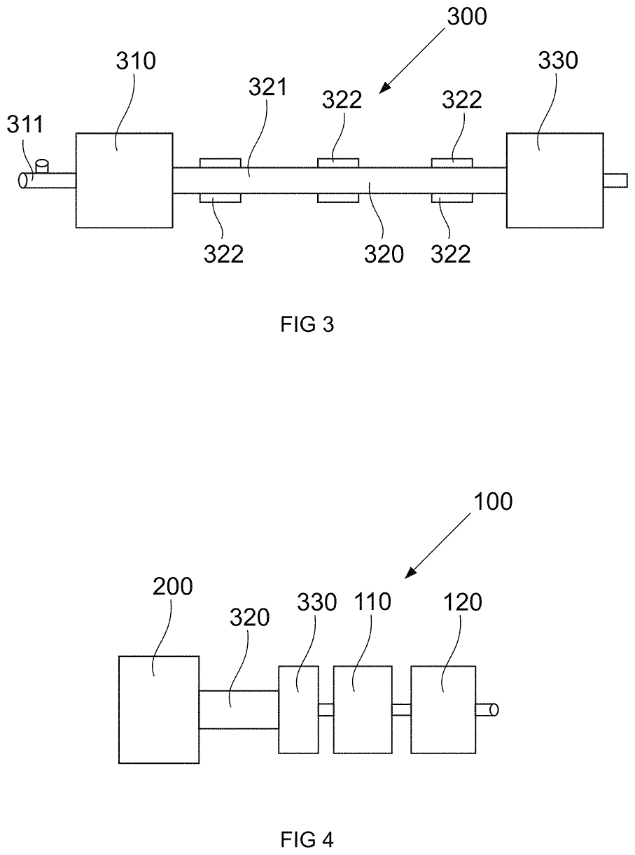

The system for purifying water from cyanide poison (300) includes a water pump (310), a catalytic reactor (320), and a sediment filter (330). The water pump (310) includes a water inlet (311) for receiving the water that is suspected of containing cyanide poison that is needed to be purified and also for receiving an iron salt solution that can be infused into the water inlet from an infusion bag. The catalytic reactor (320) comprises a pipe (321) that can be either a magnetic pipe or a pipe surrounding by magnets (322). The sediment filter (330) is designed to mechanically filter particulars from the water to the size of 5 microns. FIG. 3 depicts the system for purifying water from cyanide (300) schematically.

When the suspected water together with the iron salt solution is streamed through the catalytic reactor (320) their phase (magnetic phase) becomes identical due to the magnetic field of the catalytic reactor, and so the connection of the iron salt to the cyanide becomes very fast and only takes few seconds instead of few hours, and this creates a compound. It is recommended to add (to stream) about nine ccs of iron salt solution per one liter of suspected water. When the suspected water passes through the sediment filter (330), the compound (the iron salt together with the cyanide that is now attached) is filtered from the water, and the water discharged from the sediment filter is cyanide free.

The portable manual water purification system (100) serves as the basis for a method of purifying cyanide water that comprises the following steps.
The first step is providing the portable manual water purification system (100) that comprises the manual water pump system (200), the catalytic reactor (320), and the sediment filter (330), and further provides an ion exchange resin filter (110), and a membrane filter (120).
The second step is streaming the suspected water with the water pump system (200) connected to the catalytic reactor (320) to cause a magnetic phase of the iron salt solution and the cyanide to rotate in the same direction.
The third step is streaming the suspected water from the catalytic reactor (320) to the sediment filter (330) in which the suspected water passes, and the compound of the iron salt together with the cyanide is filtered out.

The portable manual water purification system (100) includes the manual water pump system (200), the catalytic reactor (320), the sediment filter (330), and also includes an ion exchange resin filter (110) for filtering the remainders of the ions of the iron and membranes (120) for cleaning the water by using the reverse osmosis method. The ion exchange resin filter (110) for filtering the remaining ions of the iron salt is needed mainly for preventing them from damaging the membranes (120).

FIG. 4 depicts a schematically portable manual water purification system (100). It is clear that the portable manual water purification system (100) also includes standard components known to all professionals in the field, and which are not required to be described in the present application.

The unique structure of the system (100) and the fact that it has a unique manual water pump system (200) that has been designed to generate high water pressure enough to enable water purification using the reverse osmosis method gives the system (100) a small size. This allows for it to be used to create clean water from water puddles, swamps water, standing water in dirty containers, water suspected of poisoning cyanide, and the like.

What we claim is:

1. A manual water pump system that comprises a gear increaser and a water pump; wherein the gear increaser includes an input shaft that is designed to be connected to a manual operating handle and an output shaft that is designed to be connected to a rotor shaft of the water pump; wherein said gear increaser is designed to increase the rotational speed of the input shaft and to enable the manual water pump system to create water pressures of six atmospheres.

2. A system for purifying water from cyanide that comprises a water pump, a catalytic reactor, and sediment filter; wherein the water pump includes a water inlet for receiving water that is suspected of containing cyanide poison and for receiving an iron salt solution; wherein said water pump is designed to stream the suspected water together with the iron salt solution through the catalytic reactor; wherein said catalytic reactor is designed to cause the magnetic phase of the iron salt and the cyanide to be in a same direction, whereby fasting a creation of a compound of the iron salt together with the cyanide; wherein said sediment filter is designed to mechanically filter particulars from the water to the size of 5 microns; and whereby the sediment filter can filter from the suspected water the compounds of the iron salt and the cyanide.

3. A portable manual water purification system that comprises the manual water pump system of claim 1, the catalytic reactor and the sediment filter of claim 2, and further includes an ion exchange resin filter for filtering remaining ions of the iron salt, and also a membranes for cleaning the water by using a reverse osmosis method.
